(19) United States
(12) Patent Application Publication
(10) Pub. No.: US 2026/0067803 A1
(43) Pub. Date: Mar. 5, 2026

(54) Power Saving Enhancements for Downlink Bufferable Unit (BU) Retrieval

(71) Applicant: Apple Inc., Cupertino, CA (US)

(72) Inventors: Chittabrata Ghosh, Fremont, CA (US); Morteza Mehrnoush, Hayward, CA (US); Veerendra Boodannavar, Cupertino, CA (US); Anuj Batra, Redwood City, CA (US); Yong Liu, Campbell, CA (US); Neelakantan Nurani Krishnan, San Diego, CA (US); Oren Shani, Saratoga, CA (US); Abdel Karim Ajami, Sunnyvale, CA (US)

(21) Appl. No.: 19/306,644

(22) Filed: Aug. 21, 2025

Related U.S. Application Data
(60) Provisional application No. 63/689,597, filed on Aug. 30, 2024.

(51) Int. Cl. H04W 52/02; H04L 47/2483; H04W 28/02; H04W 74/0816

(52) U.S. Cl. CPC H04W 52/0216; H04L 47/2483; H04W 28/0278; H04W 74/0816

(57) ABSTRACT

A method of retrieving downlink buffered data at a station (STA) from an access point (AP) is disclosed. The method comprises receiving, at the STA, a beacon transmitted from the AP with a traffic indication map (TIM) indicating that the AP has DL buffered data for the STA. An enhanced frame that includes a buffer status report (BSR) request is sent from the STA to the AP, and the BSR is received at the STA from the AP. A type of buffered data that the AP has for the STA is identified at the STA from the BSR. The STA determines to download at least a portion of the buffered data at the STA from the AP based on the type or amount of buffered data identified from the BSR.

### FIELD

Embodiments relate to wireless communications, including apparatuses, systems, and methods for retrieving downlink (DL) buffered data at a station (STA) from an access point (AP).

### DESCRIPTION OF THE RELATED ART

Wireless communication systems are rapidly growing in usage. People now expect to have a continuous connection with the internet regardless of where they are located. To that end, satellite communications networks, cellular communications networks, wireless local area networks, and wireless personal area networks are now ubiquitous.

Mobile electronic devices, or wireless devices, may take the form of portable, battery operated devices such as laptops, smart phones or tablets that a user typically carries. One aspect of wireless communication that may commonly be performed by wireless devices may include wireless networking, for example over a wireless local area network (WLAN), which may include devices that operate according to one or more communication standards in the IEEE 802.11 family of standards. While electronic devices, such as processors and memory, have grown exponentially in capability over the decades, the capability of batteries to supply power for the wireless devices has only improved incrementally. Accordingly, minimizing the amount of power consumed in all aspects of wireless device usage, including wireless communications, enables wireless devices to be useful for longer periods and perform more tasks between recharging. Accordingly, improvements in power savings are desired.

### BRIEF DESCRIPTION OF THE DRAWINGS

A better understanding of the present subject matter can be obtained when the following detailed description of various embodiments is considered in conjunction with the following drawings.

FIG. 1 illustrates an example wireless communication system including a user equipment device (UE) according to some embodiments.

FIG. 2 illustrates an example block diagram of a station, according to some embodiments.

FIG. 3 illustrates an example block diagram of a network element or access point, according to some embodiments.

FIG. 4 illustrates an example timing diagram of an IEEE 802.11 configuration for a downlink buffered data retrieval by a station from an AP, according to some embodiments.

FIG. 5 illustrates an example timing diagram of a modified DL buffered data retrieval, in accordance with some embodiments.

FIG. 6 illustrates an example of a more detailed timing diagram of a modified DL buffered data retrieval, in accordance with some embodiments.

FIG. 7 illustrates an example illustration of a timing diagram of a modified DL buffered data retrieval with a second enhanced frame in accordance with some embodiments.

FIGS. 8A and 8B illustrate examples of an access class (AC) bitmap and a traffic identifier (TID) bitmap in accordance with some embodiments.

FIG. 9 a flow chart of an example of a method of retrieving downlink (DL) buffered data at a station (STA) from an access point (AP), according to some embodiments.

FIG. 10 is a flow chart of an example of a method of sending DL buffered data from an AP to a STA, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium or Memory—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of stations include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” or “Access Point” has the full breadth of its ordinary meaning, and at least includes a wireless communication station installed at a fixed location and used to communicate with UEs as part of a wireless communication system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

IEEE 802.11—refers to technology based on the Institute of Electronics and Electrical Engineers (IEEE) 802.11 wireless standards such as 802.11a, 802.11.b, 802.11g, 802.11n (Wi-Fi 4), 802.11-2012, 802.11ac (Wi-Fi 5), 802.11ad, 802.11ax (Wi-Fi 6 and 6E), 802.11ay, 802.11be (Wi-Fi 7), 802.11bn (Wi-Fi 8) and/or other IEEE 802.11 standards. IEEE 802.11 technology may also be referred to as “Wi-Fi”or “wireless local area network (WLAN)”technology.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, 3GPP LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, such as Wi-Fi, WLAN channels may be 22 MHz wide, while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically-refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately-refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent-refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to”may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

The example embodiments may be further understood with reference to the following description and the related appended drawings, wherein like elements are provided with the same reference numerals. The example embodiments relate to apparatuses, systems and methods for reducing energy usage by network components, e.g., base stations in wireless communication systems.

The example embodiments are described with regard to communication between a wireless Access Point (AP) and user equipment (UE) or station (STA). However, reference to an AP, STA, or a UE is merely provided for illustrative purposes. The example embodiments may be utilized with any electronic component that may establish a connection to a network and is configured with the hardware, software, and/or firmware to support for reducing energy usage by network components in wireless communication systems. Therefore, the AP, STA or UE as described herein is used to represent any appropriate type of electronic component.

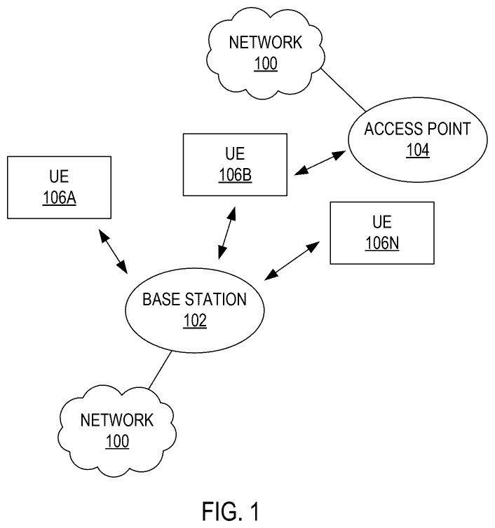

### FIG. 1: Wireless Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a cellular base station 102 which communicates over a transmission medium with one or more user devices 106A, 106B, etc., through user device 106N. Each of the user devices may be referred to herein as a “user equipment” (UE), wireless device, or station (STA). The station may be referred to as a singular device (e.g. station 106) without use of the lettering nomenclature.

The station 106 may be a device with wireless network connectivity such as a mobile phone, a hand-held device, a laptop, a wearable device, a computer or a tablet, an automobile, or virtually any type of wireless device. The station 106 may include a processor (processing element) that is configured to execute program instructions stored in memory. The station 106 may perform any of the method embodiments described herein by executing such stored instructions. Alternatively, or in addition, the station 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The base station (BS) 102 may be a base transceiver station (BTS) or cell site (a “cellular base station”) and may include hardware that enables wireless communication with the stations 106A through 106N. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the stations 106 and/or between the stations 106 and the network 100. In other implementations, base station 102 can be configured to provide communications over one or more other wireless technologies, such as an access point (AP) 104 supporting one or more WLAN protocols, such as 802.11 a, b, g, n, ac, ad, ay, be, bn and/or ax, or LTE in an unlicensed band (LAA).

The communication area (or coverage area) of the base station may be referred to as a “cell.” The base station 102 and the stations 106 may be configured to communicate over the transmission medium using any of various radio access technologies (RATs), also referred to as wireless communication technologies, or telecommunication standards, such as third generation partnership project (3GPP) Long term evolution (LTE), LTE-Advanced (LTE-A), 5G new radio (5G NR), HSPA, 3GPP2 CDMA2000 (e.g., 1xRTT, 1xEV-DO, HRPD, eHRPD), Wi-Fi, etc.

Base station 102 and other similar base stations (not shown) operating according to one or more cellular communication technologies may thus be provided as a network of cells, which may provide continuous or nearly continuous overlapping service to stations 106A-N and similar devices over a geographic area via one or more cellular communication technologies.

Note that at least in some instances a station 106 may be capable of communicating using any of multiple wireless communication technologies. For example, a station 106 might be configured to communicate using one or more of LTE, LTE-A, 5G NR, WLAN, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a station 106 may be configured to communicate using only a single wireless communication technology.

As shown, the exemplary wireless communication system also includes a wireless local area network (WLAN) access point (AP) 104, which communicates over a transmission medium with the wireless device 106B. The WLAN access point, which may be a Wi-Fi AP, also provides communicative connectivity to the network 100. Thus, according to some embodiments, wireless devices may be able to connect to either or both of the base station 102 (or another cellular base station) and the access point 104 (or another access point) to access the network 100 at a given time.

The stations 106A and 106B may include handheld devices such as smart phones or tablets, wearable devices such as smart watches or smart glasses, and/or may include any of various types of devices with cellular communications capability. For example, one or more of the stations 106A and 106B may be a wireless device intended for stationary or nomadic deployment such as an appliance, measurement device, control device, etc.

The station 106 may include one or more devices or integrated circuits for facilitating wireless communication, potentially including a cellular modem and/or one or more other wireless modems. The wireless modem(s) may include one or more processors (processor elements), and various hardware components as described herein. The station 106 may perform any of the method embodiments described herein by executing instructions on one or more programmable processors. Alternatively, or in addition, the one or more processors may be one or more programmable hardware elements such as an FPGA (field-programmable gate array), programmable logic device (PLD), application specific integrated circuit (ASIC), or other circuitry, which is configured to perform any of the method embodiments described herein, or any portion of any of the method embodiments described herein. The wireless modem(s) described herein may be used in a station as defined herein, a wireless device as defined herein, or a communication device as defined herein. The wireless modem described herein may also be used in a base station or other similar network side device.

The station 106 may include one or more antennas for communicating using one or more wireless communication protocols or radio access technologies. In some embodiments, the station device 106 might be configured to communicate using a single shared radio. The shared radio may couple to a single antenna, or may couple to multiple antennas (e.g., for MIMO) for performing wireless communications. Alternatively, the station 106 may include two or more radios, each of which may be configured to communicate via a respective wireless link. Other configurations are also possible.

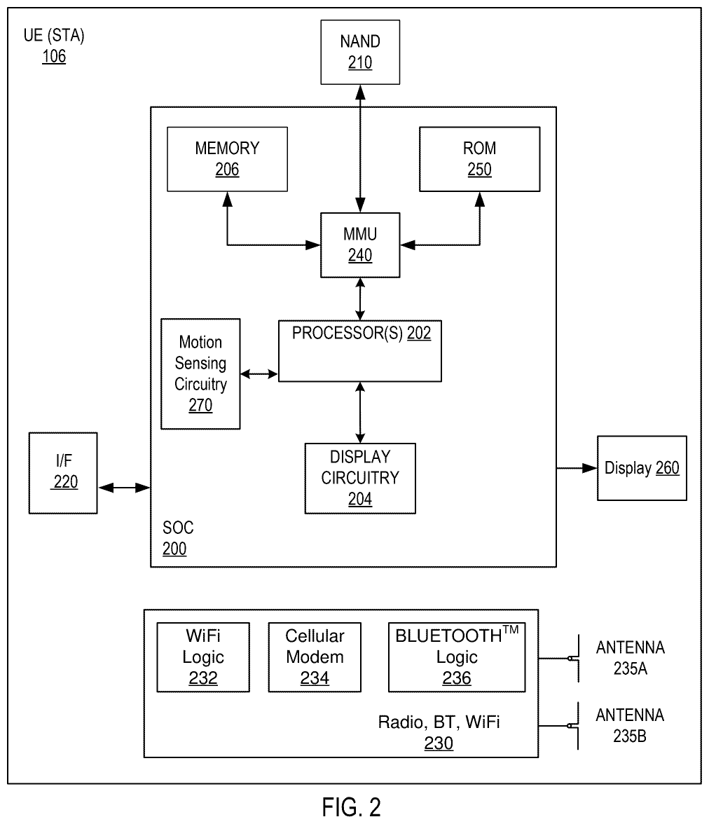

### FIG. 2: Block Diagram of a Station

FIG. 2 illustrates one possible block diagram of a station, such as station 106. In some instances (e.g., in an IEEE 802.11 communication context), the station 106 may alternatively be referred to as a station (STA) 106, and possibly more particularly as a non-AP STA 106. As shown, the station 106 may include a system on chip (SOC) 200, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 200 may be coupled to various other circuits of the station 106. For example, the station 106 may include various types of memory (e.g., including NAND flash 210), a connector interface 220 (e.g., for coupling to a computer system, dock, charging station, etc.), a display 260, and wireless communication circuitry 230 (e.g., for LTE, LTE-A, NR, CDMA2000, Bluetooth, Wi-Fi, NFC, GPS, etc.).

As shown, the SOC 200 may include processor(s) 202 which may execute program instructions for the station 106, and display circuitry 204 which may perform graphics processing and provide display signals to the display 260. The SOC 200 may also include motion sensing circuitry 270 which may detect motion of the station 106, for example using a gyroscope, accelerometer, and/or any of various other motion sensing components. The processor(s) 202 may also be coupled to memory management unit (MMU) 240, which may be configured to receive addresses from the processor(s) 202 and translate those addresses to locations in memory (e.g., memory 206, read only memory (ROM) 250, flash memory 210). The MMU 240 may be configured to perform memory protection and page table translation or set up. In some embodiments, the MMU 240 may be included as a portion of the processor(s) 202.

The station 106 may include at least one antenna, and in some embodiments, multiple antennas 235A and 235B, for performing wireless communication with access points, base stations and/or other devices. For example, the station 106 may use antennas 235A and 235B to perform the wireless communication. As noted above, the station 106 may in some embodiments be configured to communicate wirelessly using a plurality of wireless communication standards or radio access technologies (RATs).

The wireless communication circuitry 230 may include Wi-Fi Logic 232, a cellular modem 234, and Bluetooth Logic 236. The Wi-Fi Logic 232 is for enabling the station 106, operating as STA, to perform Wi-Fi or other WLAN communications on an IEEE 802.11 network. The Bluetooth Logic 236 is for enabling the station 106 to perform Bluetooth communications. The cellular modem 234 may be a cellular modem capable of performing cellular communication according to one or more cellular communication technologies such as 3GPP.

In some embodiments, the wireless communication circuitry 230 may include its own processing element (e.g., a baseband processor and/or control processor), e.g., in addition to the processing element 202. For example, the processing element 202 might be (or include) an ‘application processor’ whose function may include supporting application layer operations in the device 200, while the wireless communication circuitry 230 might include a ‘baseband processor’ (or functionally similar component(s)) whose function may include supporting baseband layer operations (e.g., to facilitate wireless communication between the device 200 and other wireless devices) in the device 200. In other words, in some cases the device 200 may include multiple processing elements (e.g., may be a multi-processor device). Other configurations (e.g., instead of or in addition to an application processor/baseband processor configuration) utilizing a multi-processor architecture are also possible.

In some embodiments, one or more of the Wi-Fi Logic 232, the Cellular modem 234, and/or the Bluetooth Logic 236 may include its own processing element (e.g., a baseband processor, control processor, or functionally similar components), e.g., in addition to the processor(s) 202. For example, the processor(s) 202 might be (or include) an ‘application processor’ that functions to support application layer operations in the device 300, while one or more of the Wi-Fi Logic 232, the Cellular modem 234, and/or the Bluetooth Logic 236 may include a baseband processor that functions to support baseband layer operations for the applicable RAT.

As described herein, station 106 may include hardware and software components for implementing embodiments of this disclosure. For example, one or more components of the wireless communication circuitry 230 (e.g., Wi-Fi logic 232, cellular modem 234, BT logic 236) of the station 106 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit). The block diagram illustrated in FIG. 2 is provided as one example. However, it is not intended to be limiting. Various elements and steps may be removed or performed differently.

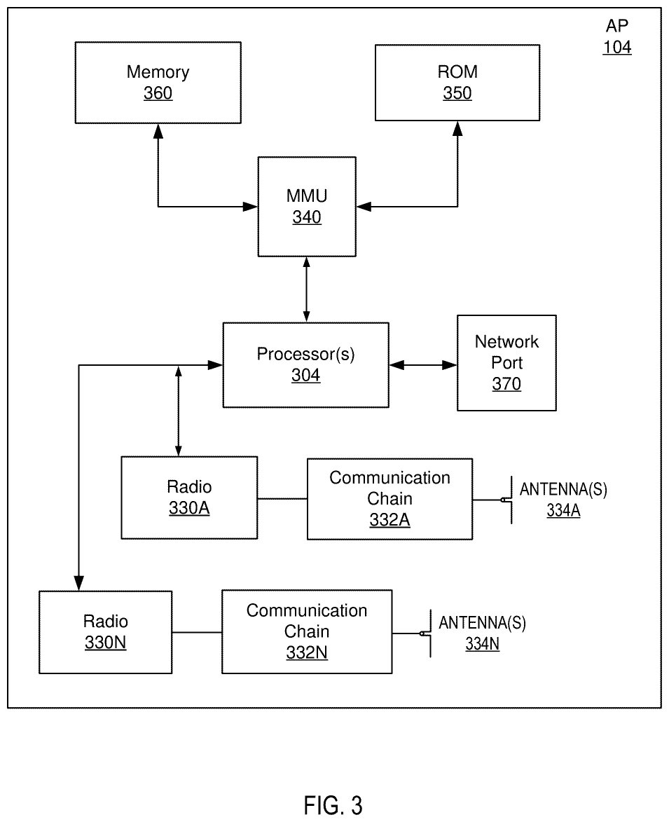

### FIG. 3: Block Diagram of an Access Point

FIG. 3 illustrates an example block diagram of an access point (AP) 104, according to some embodiments. In some instances (e.g., in an IEEE 802.11 communication context), the AP 104 may also be referred to as a station (STA), and possibly more particularly as an AP STA. It is noted that the AP of FIG. 3 is merely one example of a possible access point. As shown, AP 104 may include processor(s) 304 which may execute program instructions for the AP 104. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The AP 104 may include at least one network port 370. The network port 370 can be configured to couple to a telephone network or a data network and provide a plurality of devices, such as stations 106, access to the telephone network or the data network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as stations 106. In some cases, the network port 370 may couple to a telephone network via the core network, and/or the core network may provide a telephone network (e.g., among other stations serviced by the cellular service provider).

The AP 104 may include one or more radios 330A-330N, each of which may be coupled to a respective communication chain and at least one antenna 334, and possibly multiple antennas. The antenna(s) 334 may be configured to operate as a wireless transceiver and may be further configured to communicate with stations 106 via radio 330. The antenna(s) 334A-334N communicate with their respective radios 330A-N via communication chains 332A-332N. Communication chains 332A to 332N may be receive chains, transmit chains, or both. The radios 330A-330N may be configured to communicate via various wireless communication standards, including, but not limited to, 3GPP LTE, 3GPP LTE-A, 3GPP NR, GSM, UMTS, CDMA2000, IEEE 802.11 Wi-Fi, etc. The AP 104 may be configured to operate in multiple wireless links using the one or more radios 330A-N, wherein each radio is used to operate in a respective wireless link.

The AP 104 may be configured to communicate wirelessly using multiple wireless communication standards. In some instances, the AP 104 may include multiple radios, which may enable the network entity to communicate according to multiple wireless communication technologies. For example, as one possibility, the AP 104 may include an LTE or 5G NR radio for performing communication according to LTE as well as a Wi-Fi radio for performing communication according to Wi-Fi. In such a case, the AP 104 may be capable of operating as both an LTE base station and a Wi-Fi access point. As another possibility, the AP 104 may include a multi-mode radio which is capable of performing communications according to any of multiple wireless communication technologies (e.g., NR and Wi-Fi, NR and UMTS, LTE and CDMA2000, UMTS and GSM, etc.). As still another possibility, the AP 104 may be configured to act exclusively as an IEEE 802.11 Wi-Fi access point, e.g., without cellular communication capability.

As described further subsequently herein, the AP 104 may include hardware and software components for implementing or supporting implementation of features described herein. The processor 304 of the AP 104 may be configured to implement or support implementation of part or all of the methods described herein, e.g., by executing program instructions stored on a memory medium (e.g., a non-transitory computer-readable memory medium) to operate multiple wireless links using multiple respective radios. Alternatively, the processor 304 may be configured as a programmable hardware element, such as an FPGA (Field Programmable Gate Array), or as an ASIC (Application Specific Integrated Circuit), or a combination thereof. Alternatively (or in addition) the processor 304 of the AP 104, in conjunction with one or more of the other components 330, 332, 334, 340, 350, 360, 370 may be configured to implement or support implementation of part or all of the features described herein.

### Background of IEEE 802.11 Wi-Fi Communications

The Institute of Electronics and Electrical Engineers (IEEE) 802.11 Standard is one of the most prolific and successful communication standards in history. The 802.11 standard, first released in 1997 as a set of local area network (LAN) technical standards, specifies the set of medium access control (MAC) and physical layer (PHY) protocols for implementing wireless local area network (WLAN) computer communication. The standard has been continuously improved over the last 27 years to provide, among other things, communication with higher quality of service (QOS), higher data rates, and more efficient power usage.

Modern stations, referred to as stations or STA, such as phones, tablets, laptops, and other mobile computing devices are designed to minimize power usage to maximize battery life.

To conserve battery life, a STA, such as phones, tablets, laptops, and other mobile computing devices, may enter into a reduced power mode when not connected to a constant power supply and not actively being used (e.g., an idle state). This is typically referred to as “sleep” mode. Computer processors (e.g. central processing units and other types of processors) typically have high power consumption when they are operating. Accordingly, when processors are not needed, they are usually shut off and/or put into a low power mode, often referred to as a sleep mode, in which the processors are designed to consume very little power in order to reduce overall power consumption.

The sleep mode of particular station 106 devices may be different depending on the characteristics of the station device. For example, in the case where the station device has network access, (e.g., cellular access, Wi-Fi access, etc.), a sleep mode may include temporally putting the main processor 202 of the station to sleep and turning off the display 260 and display circuitry 204, yet keeping the network stack, such as the communications circuitry 230 in an operable function. Thus, while operating in sleep mode, an exemplary station device 106 may continue to receive information from the internet and cellular data including phone calls and/or items of interest from notification services (e.g., email messages from a push email service and/or from a pull email service) from one or more of a Wi-Fi network, a cellular network, or a Bluetooth connection. When information is received, the station 106 may be awakened to process those phone calls and/or notifications. For example, a station awakes after receiving a phone call while in sleep mode so a user may answer the phone call. Additionally, stations typically cannot refresh the data context while the station is operating in sleep mode (thus, a mobile device typically needs to be awake to refresh a data context).

One way in which power savings are accomplished in the IEEE 802.11 standard is through the use of a power save (PS) operation in which significant portions of the Wi-Fi Logic 232 are configured to operate in a reduced power manner to save power and the station is configured to reduce communication with the AP 104 only to critical time periods and packets.

During the PS operation of the Wi-Fi Logic 232, data that is typically communicated to the station 106 when it operates in an active mode, is instead buffered and stored at the AP 104. This enables the station 106 to operate at a significantly reduced power rate. For a normal STA, there are two operational modes, namely active mode and power save (PS) mode. The key idea behind the energy-saving feature is managing the operational state of the STA to optimize power usage. When the STA enters the PS mode, the corresponding downlink data is held or buffered at the Access Point (AP), instead of being transmitted immediately.

While the station 106 is in the PS mode, the AP 104 will buffer its frames. However, not all frames communicated between the station and the AP are bufferable. In order to standardize which frames are bufferable, the IEEE 802.11 standard has defined a bufferable Unit (BU). Bufferable units are eligible to be queued using a power-saving mechanism, while all others are to be delivered immediately. Accordingly, all of the DL data that is buffered at the AP for the station is a BU.

One way in which the AP 104 can communicate whether data is buffered for a specific station 106 is by transmitting a beacon to the station at a periodic rate, such as once every 100 milliseconds, or another desired periodicity.

The IEEE 802.11 standards use a bitmap to indicate to any sleeping station 106 that the AP 104 has buffered data waiting for station. The station is configured to listen to at least one beacon during a listen interval. The AP 104 periodically sends a bitmap in its beacons as an information element. The bitmap, or bit mask, is referred to as a traffic indication map (TIM). The TIM can be communicated in periodic transmission from the AP 104 referred to as beacons.

In one example, when a station 106 associates with an AP 104, the AP can assign a value called an Association ID (AID), with a range from one to 2,007. This is a numeric value assigned by the AP to identify the association. The AID can be used by the AP 104 to find any frames buffered for a selected station.

Beacons are packets sent by an AP 104 to synchronize other devices, such as station 106 A-N) operating in a wireless network, such as a WLAN. Normal TIMs that may be present in every beacon are for signaling the presence of buffered unicast data for a station 106. The station can determine if the buffered data at the AP 104 is for the station based on the AID value, which may be unique for a specific station 106. In one example, a single bit in the TIM can be used, along with the AID, to designate whether there is buffered unicast data for the specific station 106.

The TIM can also indicate whether there is broadcast or multicast data using a delivery traffic indication message (DTIM), which is a kind of TIM that is used to inform multiple stations (STA) about the presence of buffered multicast or broadcast data at the AP 104. In one example, the DTIM can be generated within the periodic beacon at a frequency specified by the DTIM interval.

In one example, the TIM may comprise 2008 bits, each bit representing the association ID (AID) of a station 106. However, in most situations an AP 104 only has data for a few station that are connected to the AP, so only the portion of the bitmap representing those station is transmitted. Because the bitmap is typically not transmitted in its entirety, it is referred to as a virtual bitmap, and the portion that is actually transmitted is referred to as a partial virtual bitmap (PVB).

The station 106 can awake at incremental periods to check for buffered data. The frequency at which a station awakes can depend on the type of station and its operation. For example, a station such as a laptop or tablet that is plugged in to a power source may connect frequently to the AP 104 to provide high data throughput. Alternatively, devices such as cell phones or other remote devices that typically operate using battery power may connect less frequently to reduce power usage. In one example, the station 106 that is plugged in to a power source may awake at every beacon, or every other beacon. While a station that operates using a battery may awake once every 5 beacons or 10 beacons (e.g. once per second), or another desired period, and check with the AP to see whether there is any data that has been buffered at the AP while the station was operating in the PS operation by checking the TIM bit and AID values (e.g. the PVB) for the station.

In the IEEE 802.11e standard released in 2005, attempts to achieve quality of service (QOS) support in WLANs were made by specifying various service classes in the MAC layer to perform the expedited delivery of high-priority packets such as voice or video data. In particular, the standard defines four access categories (ACs) which provide different opportunities for the packets to earn a transmission opportunity based on the settings assigned to the related MAC parameters. The ACs were divided into groups according to: voice data (AC3), video data (AC2), best effort data (AC1), and background data (ACO). The priority assigned to the data increases with each AC, with AC0 being the lowest priority and AC3 being the highest priority.

To add further flexibility, two traffic identifier (TID) values can be effectively assigned to each AC, resulting in 8 different TID values. The TID value assigned in the MAC layer is used to provide different QoS. A QoS-enabled 802.11 header uses the TID to classify and prioritize processing of incoming or outgoing frames based on the TID value.

In one example, the 8 TID values can be referred to as user priority (UP) values. UP values 1 and 2 are used to refer to background data (AC0). UP values 0 and 3 are used to refer to best effort data (AC1). The UP value of 0 is selected to refer to the best effort category of AC1 in order to treat a packet with no QoS marking with best effort priority. The UP value of 4 and 5 refer to video data (AC2). The UP value of 6 and 7 refer to voice data (AC3), with the highest priority. The additional TID values enable the ability to provide higher or lower QoS to certain data within the 4 designated access classes.

In addition, there are three types of frames communicated based on IEEE 802.11: management, control, or data frames. All frames fall under one of the three frame types. When a control frame (CF) is transmitted by a station 106 to an AP 104, the AP can respond with a Control Response Frame (CRF). The CF may be an initial control frame (ICF), and the CRF may be an initial control response (ICR) frame.

A transmit opportunity (TXOP) in IEEE 802.11 is a MAC feature, which increases throughput for high priority data by providing contention-free channel access for a period of time.

TXOP is available in quality of service (QOS) mode. It is a limited time period of contention-free channel access available to the channel-owning station. During such a period the station can send multiple frames that belong to a particular access category.

The benefit of TXOP is that it increases throughput and reduces delay of QoS data frames via eliminating contention periods between transmissions. TXOP can be used in combination with aggregation and block acknowledgement to further increase throughput.

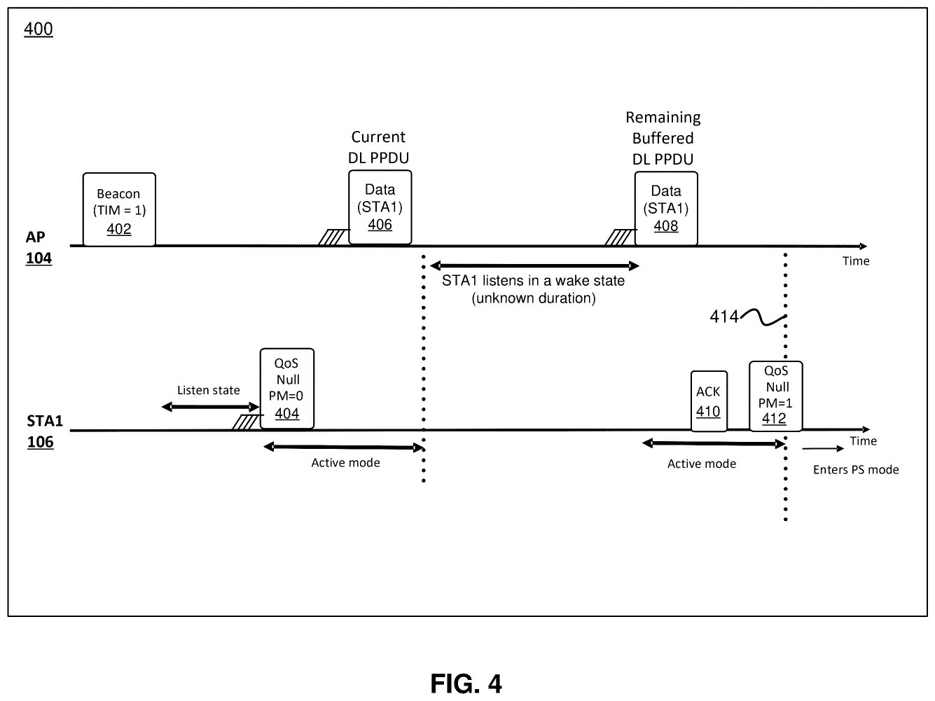

### FIG. 4: Timing Diagram of an IEEE 802.11 DL Buffered Data Retrieval

FIG. 4 illustrates an example timing diagram 400 of an IEEE 802.11 configuration for a downlink buffered data retrieval by a station 106 from an AP 104, according to some embodiments. It is noted that the timing diagram of the configuration illustrated in FIG. 4 is only one example of a possible configuration. The illustration does not include every operation in Wi-Fi communication between a station 106 and an AP 104. Rather, FIG. 4 illustrates specific operations to identify an issue in which a station may be left in an awake state and left to communicate with an AP 104 for an unknown duration. This can result in an undesirable amount of power usage which can reduce the amount of time a station may operate between battery recharges.

In the example timing diagram 400 of FIG. 4, an AP, such as AP 104, is configured to communicate with a single station, referred to as STA1. This is not intended to be limiting. The AP 104 can communicate with a plurality of stations (STA).

In the example timing diagram 400, when a station (STA1) 106 awakes from a sleep state, the station may use either active or passive scanning. In this example, the AP 104 transmits a beacon 402 with a bit in the TIM set to 1 (TIM=1) indicating that there is data for the station (STA1) in the buffer at the AP 104.

There are different types of data frames that a station 106 can transmit. One special subtype of data frame is the Null function, which is also known as Null Data that does not carry any data payload. The Null Function subtype is also used for implementing a power save feature by which client devices, such as the station (STA1) 106 in this example, inform the AP 104 about the station's (STA1) status, indicating whether the station (STA1) is operating in PS mode or is operating in an active mode.

In the example timing diagram 400 of FIG. 4, after receiving the beacon 402 with the TIM bit set to 1, indicating data is buffered at the AP 104 for the station (STA1) 106, the station (STA1) then transmits a Quality of Service (QOS) Null frame 404, with a power management indication set to zero (PM=0). The QoS Null frame 404 does not send any data. Rather, it is used to indicate to the AP 104 that the station (STA1) 106 is now operating in an active mode, which allows the station (STA1) to transmit to and receive data from the AP 104. The station (STA1) may need to wait for the medium to be clear to transmit. Accordingly, the station (STA1) enters a listening state after receiving the beacon 402 and transmits the QoS Null frame 404 with the PM set to zero when the medium is clear for the station (STA1) to transmit.

The AP 104 then transmits a data frame 406 to the station (STA1) 106, as illustrated in FIG. 4, that includes at least a portion of the downlink data that the AP 104 has buffered for the station (STA1) during the period of time that the station (STA1) was operating in a PS mode. In one example, the data frame 406 can be transmitted in a physical layer protocol data unit (PPDU). The current DL PPDU does not contain any information regarding whether the buffered data sent in the data frame is all of the buffered data for the station (STA1), or whether there is additional buffered data that still needs to be sent to the station (STA1) from the AP in a future frame. In addition, the station (STA1) does not know when a future data frame may be sent.

Accordingly, the station (STA1) 106 is configured to stay in an active mode and return to a listen state for an unknown duration of time, waiting to receive at least one additional data frame from the AP 104. Eventually, the remaining buffered DL data from the AP 104 will be transmitted to the station (STA1). In this example, the remaining buffered DL data is transmitted in a data frame, which can be a remaining buffered DL PPDU 408. The station (STA1) 106 will then send an acknowledgement (ACK) 410 that the buffered data was received in the remaining buffered DL PPDU 408, and then transmit a QoS Null frame 412 to the AP 104. In this example, the station (STA1) operates in a listen state or an active mode from the time the beacon 402 is received at the station (STA1) with the TIM=1 designating that AP 104 has buffered data for the station (STA1).

After transmitting the ACK 410, the station (STA1) can transmit a QoS Null frame 412, with a PM value set to a value of 1, when the medium is available for the station (STA1) to transmit, letting the AP 104 know that the station (STA1) has now entered a PS mode, illustrated by the dotted line 414, and the AP will need to once again buffer most DL data for the station (STA1) until the station (STA1) awakes to check the TIM value in the periodic beacon that is associated with the station's (STA1) AID value.

While only a second data frame with a remaining buffered DL PPDU 408, and a single ACK 410 are illustrated in FIG. 4, this is not intended to be limiting. A large number of data frames may be sent between the AP 104 and the station (STA1) 106 that contain the buffered DL data for the station (STA1). In addition, the station (STA1) typically transmits an ACK (or block ACK) after each data frame is received. These additional items were not included in FIG. 4 to provide a cleaner illustration.

To summarize, the current baseline behavior for buffered DL data retrieval for the station (STA1) 106 is for the station (STA1) to wake up in a periodic listen interval. If the station (STA1) observes that the TIM bit used to designate DL buffered data is set to 1 and corresponds to the station's (STA1) AID value, then the station (STA1) will remain in a listen state to retrieve the buffered DL data from the AP 104. Upon receipt of a QoS Null frame from the station (STA1) with PM=0 (e.g. 404), if the AP sends an ACK to the QoS Null Frame, then the AP can send DL PPDUs in future transmissions.

The current baseline behavior illustrated in FIG. 4 may result in the station (STA1) 106 remaining in active mode (listen state primarily) for a duration that the station (STA1) has no knowledge about. The AP can send a “More Data” signaling that contains some information about DL data in the AP buffer. However, the more data signaling sent by the AP 104, may be for a specific traffic identifier (TID) or may be aggregated over multiple TIDs. The “More Data” signaling does not provide how much data for buffer traffic for a specific flow or session; the signaling does not distinguish between different sessions. In addition, More Data signaling currently can only be transmitted from the AP to the station when the PM value is set to 1. Accordingly, the station in FIG. 4 with the PM set to 1 does not know how much data is in the AP DL buffer for different access categories (AC). Accordingly, there is an absence of information about the buffered DL data stored at the AP 104 for each AC or TID.

The time period during which the station (STA1) 106 remains in a wake state for an unknown duration to listen for an additional DL PPDU and determine if the AP has additional DL buffer data to send the station (STA1) represents a period of time in which the station (STA1) may be unnecessarily using power by remining in a wake state.

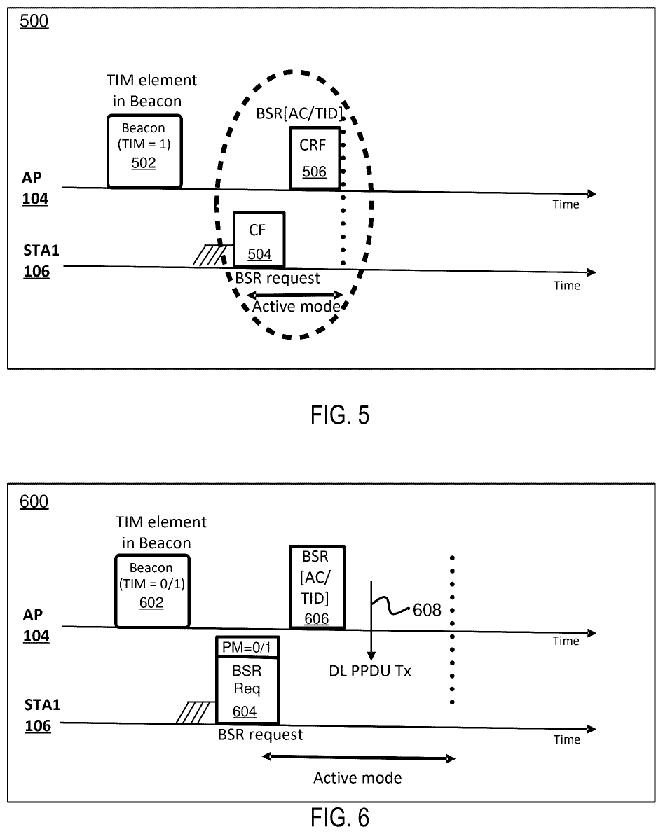

### FIGS. 5-8b: Timing Diagrams for Modified DL Buffered Data Retrieval

FIG. 5 provides an example illustration of a timing diagram 500 of a modified DL buffered data retrieval process. As previously illustrated in the timing diagram 400 of FIG. 4, the AP 104 can transmit a beacon 502 with a bit in the TIM set to a value of 1 (TIM=1) designating that there is data for the station (STA1) in the DL buffer of the AP 104 associated with the station's (STA1) AID, which may also be communicated as a PVB.

In the example timing diagram 500 of FIG. 5, instead of sending a QoS null frame with a PM=0 to inform the AP 104 that the station (STA1) 106 is set to active mode, the station (STA1) instead sends an enhanced frame to the AP that includes a buffer status report (BSR) request. The enhanced frame may still be a QOS Null frame. The QoS Null frame can include the BSR request. Alternatively, a different type of frame may be used, such as a control frame (CF) 504. The CF 504 may also be an initial control frame (ICF). The CF 504 can include the BSR request. In response, the AP 104 can transmit a control response frame (CRF) 506 that includes the buffer status report (BSR). The CRF can be a solicited CRF that may be an initial control response (ICR) frame. The station (STA1) can be in an active mode from the time that the enhanced frame is sent that includes the BSR request, until the BSR is received from the AP.

The BSR contained in the CRF 506 transmitted from the AP 104 can include detailed information about the data in the DL buffer of the AP that is for the station (STA1) 106. The BSR can include information detailing the buffered units (BU) of data for the four AC. The BSR may also include information detailing the BU for the eight TID. In one example, the BSR may include the amount of data (e.g. BU) for each AC and/or TID. For example, the BSR may indicate that there are 120 kilobits (Kb) of voice data (AC3), 2 megabits (Mb) of video data (AC2), 28 Kb of best effort data (AC1), and 0.4 Kb of background data (ACO).

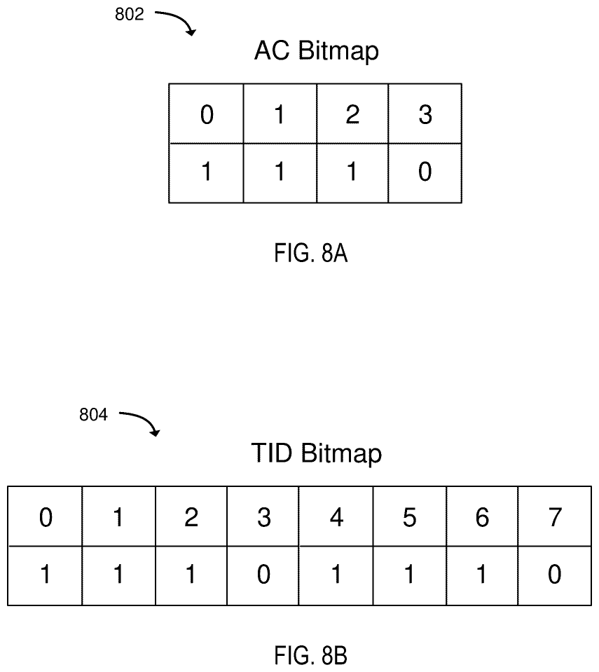

Alternatively, the BSR may include a bitmap, such as the AC bitmap 802 illustrated in FIG. 8A. In this example, the AC bitmap can include information about whether there is data (e.g. bit=1) or no data (e.g. bit=0), or vice versa, in the DL buffer of the AP for the station (STA1) for each of the four access categories. In another alternative, the BSR may include a bitmap such as the TID bitmap 804 illustrated in FIG. 8B. In this example, the TID bitmap can include information about whether there is data (e.g. bit=1) or no data (e.g. bit=0), or vice versa, in the DL buffer of the AP for the station (STA1) for each of the 8 TID categories that correspond with the four access categories. This will allow the station (STA1) 106 to determine whether there is data in each AC or TID, but the station (STA1) will not know how much data is in each AC or TID.

FIG. 6 provides an example illustration of a more detailed timing diagram 600 of a modified DL buffered data retrieval, in accordance with some embodiments. In the example of FIG. 6, the AP 104 transmits a beacon 602 with a TIM element. The TIM element may indicate that there is data for the station (STA1) 106 based on the station's (STA1) AID or PVB. An enhanced frame 604, such as a CF, ICF, QOS Null frame, or another desired frame type can be used to send the BSR request from the station (STA1) to the AP, as previously discussed in FIG. 5. In addition to sending the BSR request, the enhanced frame 604 can be used to transmit a PM indication of the station (STA1) to the AP, designating whether the station (STA1) is in an active mode or a passive mode. In the timing diagram 600 of FIG. 6, the station (STA1) is in an active mode (e.g. PM=0). Based on the information that the station (STA1) is in an active mode, the AP will send a response frame 606, such as a CRF, ICR, or other desired frame type that includes the BSR with information detailing the BU in the AP DL buffer for the AC and/or TID for the station (STA1).

Once the AP 104 has sent the BSR request, the AP can then transmit the DL PPDUs 608 to the station (STA1) 106 while the station (STA1) is in the active mode, as shown in FIG. 6. In this example, the AP can follow the baseline rule, illustrated and discussed in FIG. 4, to send the buffered DL data to the station (STA1). In one embodiment, if the PM mode field is not included in the enhanced frame 604, then it may follow the baseline procedure shown in FIG. 4 and be included in a QoS Null frame. In another alternative, the AP may assume that the station (STA1) has the same PM mode as it had prior to sending the enhanced frame 604.

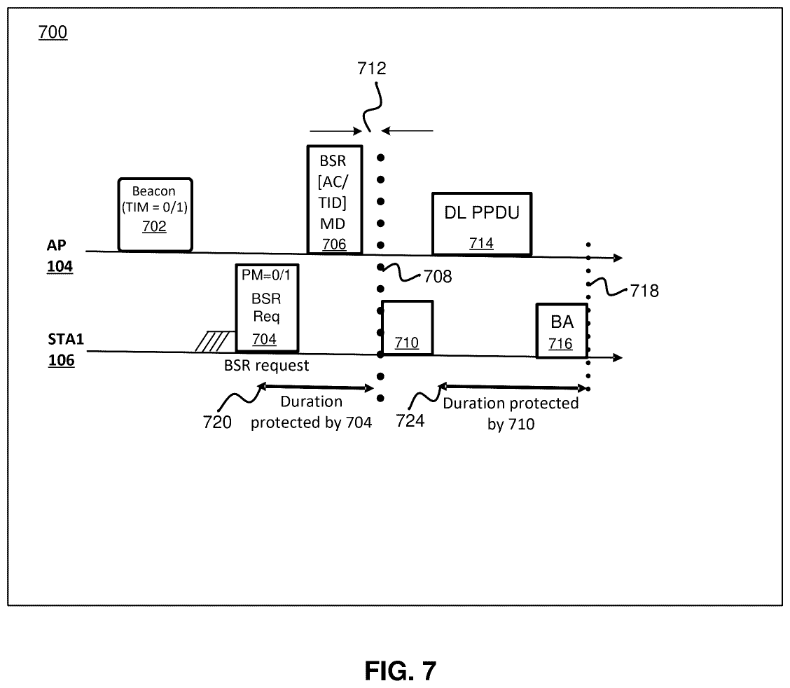

FIG. 7 provides an additional example illustration of a timing diagram 700 of a modified DL buffered data retrieval, in accordance with some embodiments. As previously discussed in FIG. 6, the AP 104 in the example of FIG. 7 can transmit a beacon 702 with a TIM element. The TIM element may indicate that there is data for the station (STA1) 106 based on the station's (STA1) AID or PVB. An enhanced frame 704, such as a CF, ICF, QOS Null frame, or another desired frame type can be used to send the BSR request from the station (STA1) to the AP, as previously discussed. In addition to sending the BSR request, the enhanced frame 704 can be used to transmit a PM indication of the station (STA1) to the AP, designating whether the station (STA1) is in an active mode or a passive mode.

In the timing diagram 700 of FIG. 7, the station (STA1) is in an active mode (e.g. PM=0). Based on the information that the station (STA1) is in an active mode, the AP will send a response frame 706, such as a CRF, ICR, or other desired frame type that includes the BSR with information detailing the BU in the AP DL buffer for the AC and/or TID for the station (STA1).

One challenge with modified DL buffered data retrieval illustrated in FIG. 7 is how to enable the station (STA1) and AP to transmit all of the frames illustrated in FIG. 7 without another station transmitting at the same time, resulting in a packet collision that may disrupt the operating. When the BSR request is sent by the station (STA1) in the enhanced frame 704, each frame in a Wi-Fi transmission contains a duration field. The duration field in the BSR request sent by the station (STA1) in the enhanced frame 704 is shown as the duration 720. The station (STA1) can extend the TXOP for the duration 720 to enable the station to receive the BSR in the response frame 706. In addition, the duration 720 protected in the enhanced frame 704 can also include additional time for a short inter-frame spacing (SIFS) time 712 that occurs after the response frame 706 is transmitted by the AP to the station (STA1) until the end of the time duration 720 at 708. The SIFS is the amount of time in microseconds required for a wireless interface to process a received frame and to respond with a response frame. In one example, the SIFS time 712 can be 16 microseconds. However, this is not intended to be limiting. The SIFS time may be set to an appropriate time that enables the frames illustrated in FIG. 7 that are communicated between the station (STA1) and the AP to be processed, and responded to, if desired. The duration value protects the duration SIFS time after the control response frame (CRF).

In the example timing diagram 700 of FIG. 7, the station (STA1) 106 can receive the response frame 706 and process the BSR within the SIFS time period and make a decision about whether to extend the TXOP based on the information received in the BSR in the response frame 706. If there is additional data in the DL buffer of the AP 104 that the station (STA1) determines to receive at that point, then the station (STA1) can transmit an additional frame, such as an additional CF, QOS Null frame, or another desired frame type. In the frame 710, the station (STA1) can send a request for the AP 104 to transmit the remaining (desired) amount of data from the DL buffer at the AP to the station (STA1). This may be all of the data in the buffer, or data in one or more AC or TID according to information received and processed in the BSR at the station (STA1). The frame 710 can also include the duration 724 to protect the medium. The STA will know how much data will be transmitted in the DL PPDU 714, and the time period for an acknowledgement or block acknowledgement (BA) 716 transmission from the station (STA1) to the AP acknowledging the data in the DL PPDU 714 was received. At the time period 718, the station (STA1) can enter a power saving mode. In one example, the station may transmit a QoS Null frame with PM=1 to indicate that the station (STA1) is in a PS mode.

In some embodiments, the BSR can include a More Data (MD) value. As previously discussed, this is a value that can be sent from the AP 104 to the station (STA1) that provides some information about the BU in the DL buffer at the AP for the station (STA1). In one example, the MD value can provide the total amount of information in the DL buffer of the AP for the station (STA1). Alternatively, the MD value can include the data for one or more AC in the DL buffer of the AP for the station (STA1). In another alternative, the MD value can include the data for one or more TID in the DL buffer of the AP for the station (STA1). In another alternative, the MD value may be an AC bitmap 802 or TID bitmap 804, as previously described and shown in FIGS. 8A and 8B.

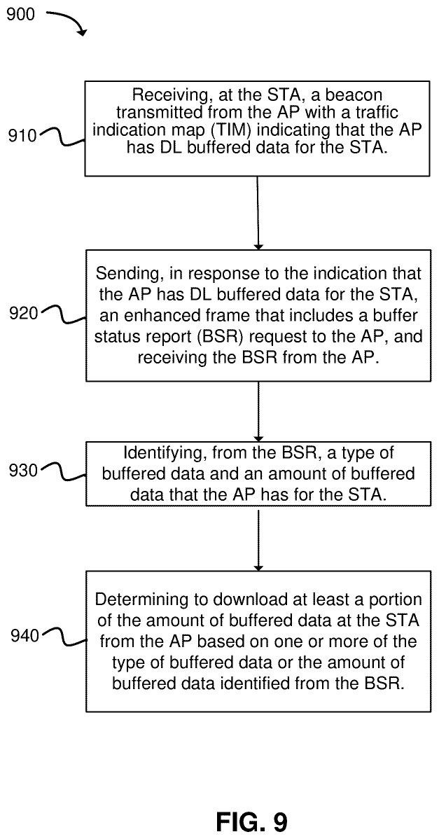

### FIG. 9: Method of Retrieving DL Buffered Data at a STA From an Ap

FIG. 9 illustrates an example flow chart of a method 900 of retrieving downlink (DL) buffered data at a station (STA) from an access point (AP), according to some embodiments.

The method shown in FIG. 9 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 900, of retrieving downlink (DL) buffered data at a station (STA) from an access point (AP), comprises receiving, at the STA, a beacon transmitted from the AP with a traffic indication map (TIM) indicating that the AP has DL buffered data for the STA, as in block 910. In response to the indication that the AP has DL buffered data for the STA, an enhanced frame is sent that includes a buffer status report (BSR) request to the AP, and the BSR is received from the AP, as shown in block 920. A type of buffered data and an amount of buffered data can be identified from the BSR that the AP has for the STA, as shown in block 930. The STA can determine to download at least a portion of the buffered data at the STA from the AP based on one or more of the types of buffered data or the amount of buffered data identified from the BSR, as shown in block 940.

In some embodiments, the method 900 further comprises receiving the beacon with the TIM after the STA has been in a power saving mode. The BSR request can be sent in the enhanced frame, wherein the enhanced frame is one of a control frame, an initial control frame, or a quality of service null frame. The BSR can be received from the AP in one of a control response frame (CRF), or an initial control response (ICR) frame.

The operation of identifying the type of buffered data in the method 900 further comprises identifying the type of buffered data from the BSR as data that is in one or more access categories (AC) or one or more traffic identifiers (TID). An amount of data in the BSR can be identified in the one or more ACs or the one or more TIDs.

In some embodiments, the method 900 comprises identifying in an AC bitmap in the BSR, when data is in the one or more ACs or is not in the one or more ACs; or in a TID bitmap in the BSR, when data is in the one or more TIDs or is not in the one or more TIDs.

In some embodiments, a more data value is used by the AP to report the presence of data that is in the one or more ACs or in the one or more TIDs, and the more data value is used when the PM is set to 1 and when the PM is set to 0. The more data value is typically only used when the PM value is set to one. In one example, the more data value indication is used to report the data that is in the one or more ACs or in the one or more TIDs when the PM value is set to zero. In one example, the PM indication is in the initial control frame (a BSR request frame).

In some embodiments, the method 900 further comprises sending a power management (PM) indication of the STA to the AP in the enhanced frame to enable the AP to identify that the STA is in an active mode and can receive at least a portion of the DL buffered data for the STA in a transmission from the AP.

In some embodiments, the method 900 further comprises sending a duration time period to AP in the enhanced frame, wherein the duration time period identifies a time to protect a transmission medium between the STA and the AP. The duration time period can include a short inter-frame spacing value to include an amount of time in the duration time period for the STA to process the enhanced frame and to respond with a response frame.

In some embodiments, determining to download the at least a portion of the buffered data at the STA based on the type of buffered data further comprises transmitting, an additional enhanced frame, from the STA to the AP, that includes a request for the AP to transmit the at least a portion of the buffered data, based on the type of buffered data or the amount of buffered data indicated in the BSR.

In some embodiments, determining to download the at least a portion of the buffered data at the STA further comprises transmitting an additional enhanced frame from the STA to the AP that includes a request for the AP to transmit at least one type of buffered data from the type of buffered data indicated in the BSR.

In some embodiments, a duration time period can be sent to the AP in the additional enhanced frame, wherein the duration time period identifies a time to protect a transmission medium in a transmission opportunity (TXOP) between the STA and the AP during the download of the at least a portion of the buffered data and a block acknowledgement sent from the STA to the AP.

In some embodiments, a baseband processor is configured to cause a station (STA) to perform any of the operations of the method 900.

In some embodiments, an apparatus is configured to cause a station (STA), having one or more processors coupled to a memory, to perform any of the operations of the method 900.

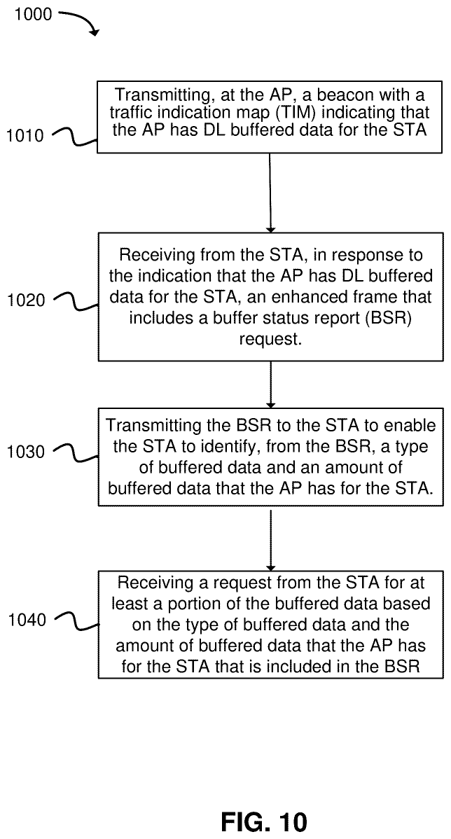

### FIG. 10: Method of Sending DL Buffered Data From an Ap to a Sta

FIG. 10 illustrates an example flow chart of a method 1000 of sending downlink (DL) buffered data from an access point (AP) to at a station (STA), according to some embodiments.

The method shown in FIG. 10 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1000, of sending downlink (DL) buffered data from an access point (AP) to at a station (STA), comprises transmitting, at the AP, a beacon with a traffic indication map (TIM) indicating that the AP has DL buffered data for the STA, as shown in block 1010. The AP can receive, from the STA, in response to the indication that the AP has DL buffered data for the STA, an enhanced frame that includes a buffer status report (BSR) request, as shown in block 1020. The AP can transmit the BSR to the STA to enable the STA to identify, from the BSR, a type of buffered data and an amount of buffered data that the AP has for the STA, as shown in block 1030. A request can be received from the STA for at least a portion of the buffered data based on the type of buffered data and the amount of buffered data that the AP has for the STA that is included in the BSR, as shown in block 1040.

In some embodiments, the method 1000 further comprises transmitting the beacon with the TIM after the STA was in a power saving mode. The BSR request can be received in the enhanced frame, wherein the enhanced frame is one of a control frame, an initial control frame, or a quality of service null frame. The BSR can be transmitted from the AP in one of a control response frame (CRF), or an initial control response (ICR) frame.

In some embodiments, identifying the type of buffered data in the method 1000 further comprises identifying the type of buffered data from the BSR as data that is in one or more access categories (AC) or one or more traffic identifiers (TID).

In some embodiments, a baseband processor configured to cause an access point (AP) to perform one or more of the operations of the method 1000 is disclosed.

In some embodiments, an apparatus configured to cause an access point, having one or more processors coupled to a memory, to perform any of the operations of the method 1000 is disclosed.

In some embodiments, a computer program product, comprising computer instructions which, when executed by one or more processors, perform any of the operations described herein.

Although the embodiments above have been described in considerable detail, numerous variations and modifications will become apparent to those skilled in the art once the above disclosure is fully appreciated. It is intended that the following claims be interpreted to embrace all such variations and modifications.

1. A method of retrieving downlink (DL) buffered data at a station (STA) from an access point (AP), comprising:
receiving, at the STA, a beacon transmitted from the AP with a traffic indication map (TIM) indicating that the AP has DL buffered data for the STA;
sending, in response to the TIM indication that the AP has DL buffered data for the STA, an enhanced frame that includes a buffer status report (BSR) request to the AP;
receiving a buffer status report (BSR) from the AP;
identifying, from the BSR, a type of buffered data and an amount of buffered data that the AP has for the STA; and
determining to download at least a portion of the amount of buffered data at the STA from the AP based on one or more of the type of buffered data or the amount of buffered data identified from the BSR.

2. The method of claim 1, further comprising receiving the beacon with the TIM after the STA has been in a power saving mode.

3. The method of claim 1, further comprising sending the BSR request in the enhanced frame, wherein the enhanced frame is one of a control frame, an initial control frame, or a quality of service null frame.

4. The method of claim 1, further comprising receiving the BSR from the AP in one of a control response frame (CRF), or an initial control response (ICR) frame.

5. The method of claim 1, wherein identifying the type of buffered data further comprises identifying the type of buffered data from the BSR as data that is in one or more access categories (AC) or one or more traffic identifiers (TID).

6. The method of claim 5, further comprising determining an amount of data in the BSR in the one or more ACs or the one or more TIDs.

7. The method of claim 5, further comprising identifying:
in an AC bitmap in the BSR, when data is in the one or more ACs or is not in the one or more ACs; or
in a TID bitmap in the BSR, when data is in the one or more TIDs or is not in the one or more TIDs.

8. The method of claim 5, wherein a more data value is used by the AP to report a presence of data that is in the one or more ACs or in the one or more TIDs, and the more data value is used when a power management (PM) indication is set to 1 and when the PM indication is set to 0.

9. The method of claim 5, wherein a more data value is used by the AP to report a presence of data that is in the one or more ACs or the one or more TIDs, and the more data value is used when a power management (PM) indication is set to 0.

10. The method of claim 1, further comprising sending a power management (PM) mode of the STA to the AP in the enhanced frame to enable the AP to identify that the STA is in an active mode and can receive at least a portion of the DL buffered data for the STA in a transmission from the AP.

11. The method of claim 1, further comprising sending a duration time period to the AP in the enhanced frame, wherein the duration time period identifies a time to protect a transmission medium between the STA and the AP.

12. The method of claim 11, wherein the duration time period includes a short inter-frame spacing value to include an amount of time in the duration time period for the STA to process the enhanced frame and to respond with a response frame.

13. The method of claim 1, wherein determining to download the at least a portion of the buffered data at the STA based on the amount of buffered data and the type of buffered data further comprises transmitting an additional enhanced frame from the STA to the AP that includes a request for the AP to transmit the at least a portion of the buffered data, based on the type of buffered data or an amount of buffered data indicated in the BSR.

14. The method of claim 1, wherein determining to download the at least a portion of the buffered data at the STA further comprises transmitting an additional enhanced frame from the STA to the AP that includes a request for the AP to transmit at least one type of buffered data from the type of buffered data indicated in the BSR.

15. The method of claim 13, further comprising sending a duration time period to the AP in the additional enhanced frame, wherein the duration time period identifies a time to protect a transmission medium in a transmission opportunity (TXOP) between the STA and the AP during the download of the at least a portion of the buffered data and a block acknowledgement sent from the STA to the AP.

16. A method of sending downlink (DL) buffered data from an access point (AP) to at a station (STA), comprising:
transmitting, at the AP, a beacon with a traffic indication map (TIM) indicating that the AP has DL buffered data for the STA;
receiving from the STA, in response to the indication that the AP has DL buffered data for the STA, an enhanced frame that includes a buffer status report (BSR) request;
transmitting the BSR to the STA to enable the STA to identify, from the BSR, a type of buffered data and an amount of buffered data that the AP has for the STA; and
receiving a request from the STA for at least a portion of the buffered data based on the type of buffered data and the amount of buffered data that the AP has for the STA that is included in the BSR.

17. The method of claim 16, further comprising transmitting the beacon with the TIM after the STA was in a power saving mode.

18. The method of claim 16, further comprising receiving the BSR request in the enhanced frame, wherein the enhanced frame is one of a control frame, an initial control frame, or a quality of service null frame.

19. The method of claim 16, further comprising transmitting the BSR from the AP in one of a control response frame (CRF), or an initial control response (ICR) frame.

20. The method of claim 16, wherein identifying the type of buffered data further comprises identifying the type of buffered data from the BSR as data that is in one or more access categories (AC) or one or more traffic identifiers (TID).
